(19) United States
(12) Patent Application Publication
(10) Pub. No.: US 2008/0143925 A1
(43) Pub. Date: Jun. 19, 2008

(54) LAMP AND LIQUID CRYSTAL DISPLAY DEVICE HAVING THE SAME

(75) Inventors: Hyun-jin KIM, Seoul (KR); Seok-hyun NAM, Seoul (KR); Sang-hyuck YOON, Seoul (KR); Chi-o CHO, Asan-si (KR); Kyung-min KIM, Asan-si (KR); Min-jeong WANG, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/947,302

(22) Filed: Nov. 29, 2007

(30) Foreign Application Priority Data
Dec. 13, 2006 (KR) 10-2006-0126864

(51) Int. Cl. G02F 1/1335; H01J 63/00

(52) U.S. Cl. 349/70; 313/509

(57) ABSTRACT

A lamp and liquid crystal display device having the same include a tube which forms a light emitting space, an electrode main body disposed in an end part of the tube, a dielectric layer formed on the electrode main body and a surface metal layer formed on the dielectric layer. The electrode main body and the dielectric layer form a capacitor which prevents a current imbalance when a plurality of the lamps are connected in electrical parallel to each other and are driven by a transformer.

This application claims priority to Korean Patent Application No. 2006-0126864, filed on Dec. 13, 2006, and all the benefits accruing therefrom under 35 U.S.C. § 119, the contents of which in its entirety are herein incorporated by reference.

### BACKGROUND OF THE INVENTION

(a) Field of the Invention

The present invention relates to a lamp and a liquid crystal display having the same, and more particularly, to a lamp and a liquid crystal display having the same in which an unbalanced electrical current supplied to the lamp is effectively reduced or eliminated.

(b) Description of the Related Art

Recently, a flat display device such as a liquid crystal display (“LCD”), a plasma display panel (“PDP”) or an organic light emitting diode (“OLED”) has been developed to replace a cathode ray tube (“CRT”).

An LCD device includes an LCD panel. The LCD panel includes a first substrate having a thin film transistor, a second substrate facing the first substrate and a liquid crystal layer interposed between the first and second substrates. The LCD panel itself does not emit light, rather, the LCD panel receives light from a backlight unit which is disposed behind the first substrate.

A lamp which requires a high driving voltage is commonly used as a light source for the backlight unit. To supply the high voltage, an inverter which includes a transformer is commonly provided in the LCD device.

If a plurality of lamps are connected in electrical parallel with each other and are supplied with electrical currents from a single transformer, a current supplied by the transformer to a single lamp of the plurality of lamps may be unbalanced, e.g., the current supplied to the single lamp of the plurality of lamps may not be equal to a current supplied to another individual lamp of the plurality of lamps. To prevent currents from being unbalanced, a balance board which has a capacitor is used or, alternatively, multiple transformers may be provided for each lamp. These methods result in a complicated configuration for the LCD device and raise production costs. Thus, it is desired to provide a lamp which does not require a balance board or multiple transformers and which does not cause a current imbalance when the lamp is driven in electrical parallel with other lamps in an LCD device.

### BRIEF SUMMARY OF THE INVENTION

According to an exemplary embodiment of the present invention, a liquid crystal display device includes a lamp which does not cause a current imbalance when driven in electric parallel with other lamps without the use of a balance board or multiple transformers.

The foregoing and/or other aspects, features and advantages of the present invention can be achieved by providing an exemplary embodiment of a lamp. The lamp includes a tube which forms a light emitting space therein, an electrode main body disposed in a first end part of the tube; a dielectric layer formed on the electrode main body disposed in the first end part of the tube, and a surface metal layer formed on the dielectric layer.

A work function of the electrode main body is greater than a work function of the surface metal layer.

The electrode main body includes at least one of copper, aluminum and stainless steel.

The surface metal layer includes at least one of nickel (Ni), niobium (Nb), molybdenum (Mo) and cesium (Cs).

The dielectric layer includes at least one of silica (“SiO₂”), tantalum dioxide (“Ta₂O₅”), lead zirconate titanate (“Pb[ZrTi]O₃”) or (“PZT”), barium strontium titanate (“[BaSr]TiO₃”) or (“BST”), strontium titanate oxide (“SrTiO₃”) or (“STO”) and polarized lead zirconium titanate (“[PbLa] [ZrTi]O₃”) or (“PLZT”).

The tube includes glass, and a permittivity of the dielectric layer is greater than a permittivity of the tube.

The lamp further includes a protection layer which is formed on a first inner surface of the tube, and a fluorescent layer which is formed on the protection layer.

The electric main body has a tapered cylindrical shape, in which a first end of the tapered cylindrical shape is wider near the light emitting space and which tapers to a narrower second end of the tapered cylindrical shape which is near a first end of the electrode main body.

The foregoing and/or other aspects, features and advantages can be achieved by providing a liquid crystal device according to an alternative exemplary embodiment of the present invention, wherein the liquid crystal display device includes a liquid crystal display panel, a plurality of lamps disposed behind the liquid crystal display panel and an inverter which supplies power to the plurality of lamps.

The plurality of lamps comprising a tube which forms a light emitting space therein and an electrode disposed in a first end part of the tube.

The electrode includes an electrode main body, a dielectric layer formed on the electrode main body and a surface metal layer formed on the dielectric layer.

The inverter includes a transformer electrically connected to the plurality of lamps. Individual lamps of the plurality of lamps are connected in electrical parallel with each other. A work function of the electrode main body is greater than a work function of the surface metal layer.

The electrode main body includes at least one of copper, aluminum and stainless steel.

The surface metal layer includes at least one of nickel (Ni), niobium (Nb), molybdenum (Mo) and cesium (Cs).

The dielectric layer comprises at least one of silica (“SiO₂”), tantalum dioxide (“Ta₂O₅”), lead zirconate titanate (“Pb[ZrTi]O₃”) or (“PZT”), barium strontium titanate (“[BaSr]TiO₃”) or (“BST”), strontium titanate oxide (“SrTiO₃”) or (“STO”) and polarized lead zirconium titanate (“[PbLa] [ZrTi]O₃”) or (“PLZT”).

The tube includes glass, and a permittivity of the dielectric layer is larger than a permittivity of the tube.

### BRIEF DESCRIPTION OF THE DRAWINGS

The above and other aspects, features and advantages of the present invention will become apparent by describing in further detail exemplary embodiments thereof with respect to the accompanying drawings, in which:

FIG. 1 is an exploded perspective view of a liquid crystal display device according to an exemplary embodiment of the present invention;

FIG. 2 is an exploded perspective view of main parts of the liquid crystal display device of FIG. 1 according to an exemplary embodiment of the present invention;

FIG. 3 is a partial cross-sectional view of a lamp which is used in the liquid crystal display device of FIG. 1 according to an exemplary embodiment of the present invention;

FIG. 4 is a schematic circuit diagram of a power supply for the lamp of FIG. 3 according to an exemplary embodiment of the present invention;

FIG. 5 is a schematic circuit diagram of a power supply for a lamp of a liquid crystal display device according to an alternative exemplary embodiment of the present invention;

FIG. 6 is a partial cross-sectional view of a lamp of a liquid crystal display device according to another exemplary embodiment of the present invention;

FIG. 7 is a schematic circuit diagram of a power supply for the lamp of FIG. 6 according to an exemplary embodiment of the present invention;

FIG. 8 is a schematic circuit diagram of a power supply for a lamp of a liquid crystal display device according to another alternative exemplary embodiment of the present invention; and

FIGS. 9 and 10 are perspective views illustrating different types of lamps which are used in exemplary embodiments of the present invention.

### DETAILED DESCRIPTION OF THE INVENTION

The invention now will be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

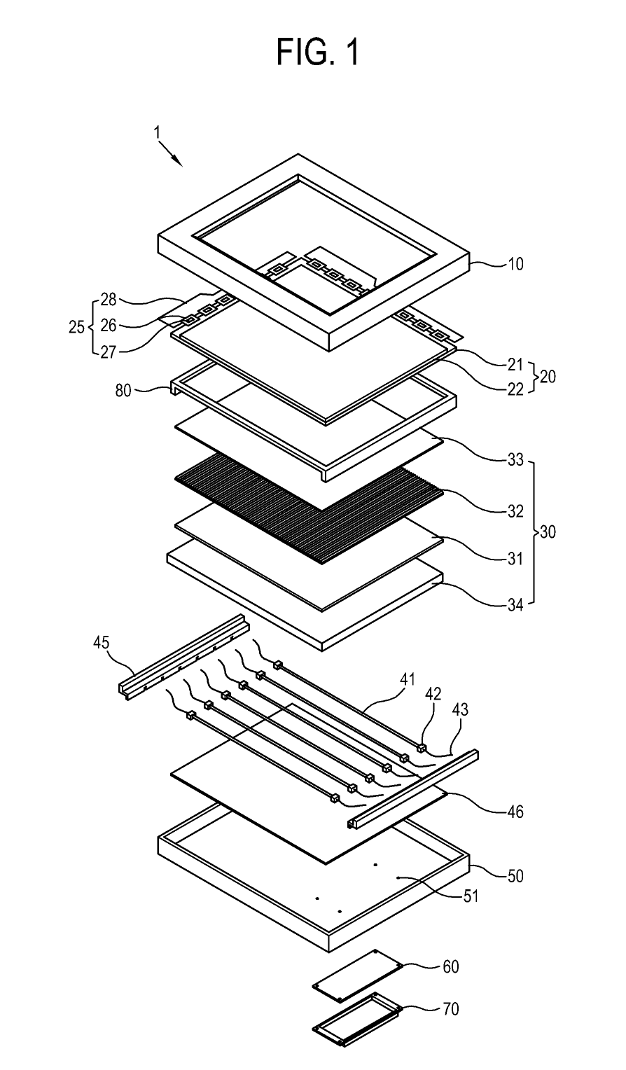

Hereinafter, a lamp according to an exemplary embodiment of the present invention will be described in further detail with reference to the accompanying drawings. In exemplary embodiments, the lamp is used in a liquid crystal display (“LCD”) device, as described in further detail now with reference to FIGS. 1 to 4. In alternative exemplary embodiments of the present invention, the lamp may be used in lighting devices other than the liquid crystal display device described herein.

As illustrated in FIG. 1, a liquid crystal display device 1 includes a liquid crystal display panel 20, an optical member 30 which is disposed behind the liquid crystal display panel 20, a lamp 41 which is disposed behind the optical member 30 and a reflection plate 46 which is provided behind the lamp 41. The liquid crystal display panel 20 is mounted on a panel supporting mold 80 and an end part (not labeled) of the lamp 41 is surrounded by a lamp supporter 42. The lamp supporter 42 is accommodated in a side mold 45. The foregoing elements are accommodated between an upper cover 10 and a lower cover 50, as illustrated in FIG. 1.

The liquid crystal display panel 20 includes a first substrate 21 on which a thin film transistor (“TFT”) is formed, and a second substrate 22 which faces the first substrate 21. A liquid crystal layer (not shown) is disposed between the first substrate 21 and the second substrate 22. The liquid crystal display panel 20 displays an image in response to an alignment of liquid crystals in the liquid crystal layer, but the liquid crystal display 20 does not emit light itself and thus must receive light from the lamp 41 disposed behind the optical member 30 and LCD panel 20, as illustrated in FIG. 1.

A driver 25 which supplies a driving signal to the LCD panel 20 is provided on a lateral part of the first substrate 21. The driver 25 includes a flexible printed circuit board (“FPCB”) 26, a driving chip 27 which is mounted on the FPCB 26 and a printed circuit board (“PCB”) 28 which is connected to a side of the FPCB 26 and to the first substrate 21. According to an exemplary embodiment of the present invention, the driver 25 is a chip on film (“COF”), but is not limited thereto in alternative exemplary embodiments. For example, the driver 25 may employ other known mounting methods, including a tape carrier package (“TCP”) and a chip on glass (“COG”), but is not limited thereto. In yet another alternative exemplary embodiment, the driver 25 may be formed on the first substrate 21.

The optical member 30 which is disposed behind the liquid crystal display panel 20 includes a diffusion film 31, a prism film 32, a protection film 33 and a diffusion plate 34.

The diffusion film 31 diffuses light which is incident from the diffusion plate 34, and prevents a bright, e.g., concentrated, line from to the lamp 41.

The prism film 32 includes triangular prisms which are arranged at predetermined intervals on an upper surface (not shown) thereof. The prism film 32 reflects light which is diffused by the diffusion film 31 such that the reflected light is incident to a surface of the liquid crystal display panel 20 in a substantially perpendicular manner. In an exemplary embodiment of the present invention, the prism film 32 is provided as a plurality of individual prism films (not shown) and a micro prism is formed at a predetermined angle on each of the individual prism films of the plurality of individual prism films. Thus, the reflected light from the prism film 32 travels in a substantially vertical direction in the LCD device 1 of FIG. 1 to provide uniform brightness distribution to the liquid crystal display panel 20.

The protection film 33 which is provided between the liquid crystal display panel 20 and the prism film 32 protects the prism film 32 from scratches and/or other damage.

The diffusion plate 34 which is disposed under the diffusion film 31 may include polymethyl methacrylate (“PMMA”) or poly carbonate (“PC”). The diffusion plate 34 may include a diffusing agent (not shown) which is dispersed therein. Alternatively, the diffusion plate 34 may be coated with a diffuser layer (not shown). The end parts of the diffusion plate 34 are seated on the side mold 45. Here, the diffusion plate 34 is made with a sufficient thickness and strength such that the diffusion plate 34 is not easily deformed toward the reflection plate 46. The liquid crystal display device 1 may further include a supporter (not shown) to keep the distance between the diffusion plate 34 and the reflection plate 46 uniform. In an exemplary embodiment of the present invention, the liquid crystal display device 1 includes a plurality of lamps 41. Further, individual lamps of the plurality of lamps are connected in electrical parallel to each other. The configuration of the lamps 41 will be described later in further detail.

Still referring to FIG. 1, the lamps 41 are arranged across a rear part of the liquid crystal display panel 20. In alternative exemplary embodiments, the liquid crystal display device 1 may include a light guiding plate (not shown) and the lamp 41 may be provided at a lateral side of the light guiding plate.

The lamp supporter 42 surrounds opposite ends of the lamps 41 and is accommodated in the side mold 45. The side mold 45 includes a plastic material, for example, but is not limited thereto, a surface of which may be coated with a reflection layer to improve reflection properties.

The reflection plate 46 is disposed under the lamps 41 and reflects light toward the diffusion plate 34. The reflection plate 46 may include a plastic material such as polyethylene terephthalate (PET) or poly carbonate (PC), for example, but is not limited thereto.

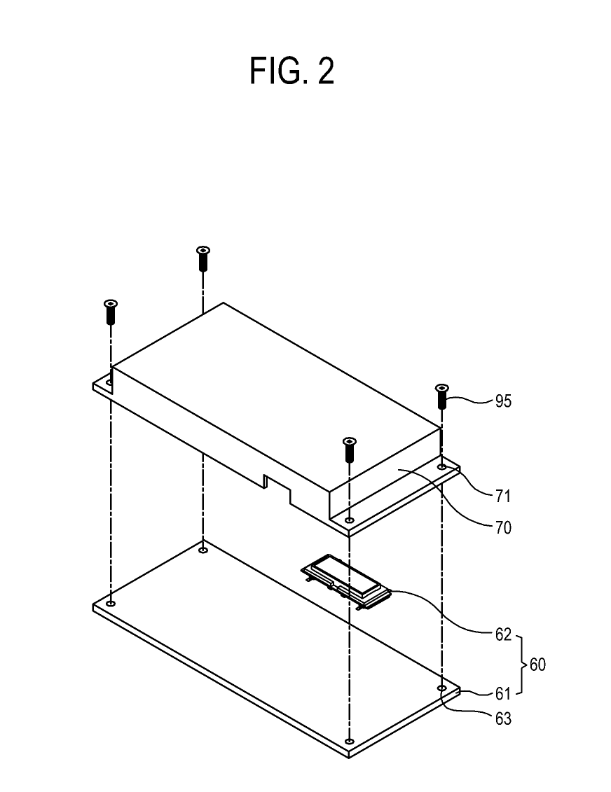

Referring to FIGS. 1 and 2, an inverter 60 is provided behind the lower cover 50 to drive the lamps 41. The inverter 60 is covered with an inverter cover 70. The inverter 60 includes an inverter substrate 61 and a transformer 62 which is mounted on the inverter substrate 61.

The inverter 60 is mounted to the lower cover 50 of the LCD device 1 with inverter mounting screws 95 disposed through a plurality of inverter mounting holes 71 in the inverter cover 70, a plurality of inverter substrate mounting holes 63 in the inverter substrate 61 and a plurality of inverter mounting holes 51 in the lower cover 50, as illustrated in FIGS. 1 and 2.

The inverter cover 70 may include a plastic material, for example, but is not limited thereto, to save costs and decrease weight.

The lamps 41 receive power from the inverter 60 through a cable 43.

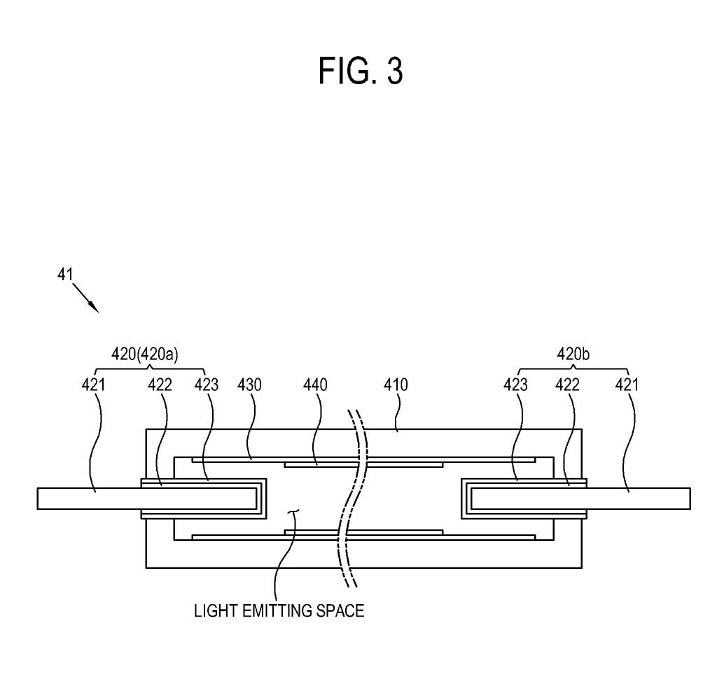

The lamps 41 will be described in further detail hereinafter with reference to FIG. 3.

The lamps 41 include a tube 410 which forms a light emitting space therein, electrodes 420 which are disposed in opposite ends of the tube 410, a protection layer 430 formed on an inner surface of the tube 410 and a fluorescent layer 440 formed on the protection layer 430. The light emitting space is filled with mercury, argon or neon, for example, but is not limited thereto.

The tube 410 is elongated and may include glass or other appropriate material.

The electrodes 420 include a first electrode 420a and a second electrode 420b (hereinafter collectively referred to as “electrodes 420”). The electrode main body 421 of the first electrode 420a and the second electrode 420b includes a portion which is inside the light emitting space and a portion which is outside the light emitting space as illustrated in FIG. 3. Further, first electrode 420a and the second electrode 420b each include a dielectric layer 422 which covers a surface of the electrode main body 421, and a surface metal layer 423 which covers a surface of the dielectric layer 422. In an exemplary embodiment of the present invention, the dielectric layer 422 and the surface metal layer 423 are formed on the portion of the electrode main body 421 which is inside the light emitting space, but in an alternative exemplary embodiment, the dielectric layer 422 and the surface metal layer 423 may be formed on the portion of the electrode main body 421 which is outside the light emitting space.

The components and configuration of the second electrode 420b are the same as those of the first electrode 420a, and therefore will not be described separately herein.

The electrode main body 421 is not physically exposed to the light emitting space. Rather, the portion of the electrode main body 421 which is inside the light emitting space is covered with the dielectric layer 422 and the surface metal layer 423. The portion of the electrode main body 421 which is outside the light emitting space is connected with the cable 43 (FIG. 1) through a solder connection (not shown). Further, the lamp supporter 42 surrounds the solder connection part between the electrode main body 421 and the cable 43.

In alternative exemplary embodiments, the portion of the electrode main body 421 which is outside the light emitting space may be connected to the cable 43 with a socket, and then with the inverter 60 (FIGS. 1 and 2) through the socket. In this case, a lamp supporter 42 and the solder connection are not used.

The operation of the lamps 41 according to an exemplary embodiment of the present invention will be described in further detail hereinafter with reference to FIGS. 3 to 5.

The dielectric layer 422 and the electrode main body 421 of the first electrode 420a and the second electrode 420b form capacitors C₁ and C₂, respectively. When power is supplied through the portion of the electrode main body 421 which is outside the light emitting space, electrons are emitted from the surface metal layer 423 by a high-voltage electric field between the electrodes 420a and 420b.

When the electrons are emitted, mercury, for example, but is not limited thereto, which is in the light emitting space, is excited by the electrons and emits ultraviolet rays. The ultraviolet rays collide with the fluorescent layer 440 creating visible light rays which are emitted from the lamps 41.

To facilitate emission of the ultraviolet rays, the surface metal layer 423 includes a material having a low work function, e.g., a low minimum energy required to emit electrons, to emit electrons easily. Further, the work function of the surface metal layer 423 is smaller than that of the electrode main body 421. Accordingly, the surface metal layer 423 may include, for example, nickel (Ni), niobium (Nb), molybdenum (Mo) or cesium (Cs), but is not limited thereto.

When the surface metal layer 423 includes a material having a low work function, low temperature and black-start properties of the lamps 41 are thereby improved.

The surface metal layer 423 may be formed by an electrolysis, plating, vaporization, sputtering or chemical vapor deposition (“CVD”) method, for example, but is not limited thereto.

The electrode main body 421 does not emit electrons itself, and thus may include a material having a high work function relative to the work function of the surface metal layer 423. Further, the electrode main body 421 includes a material with high conductivity, such as copper, aluminum or stainless steel, for example, but is not limited thereto. In alternative exemplary embodiment, the electrode main body 421 and the surface metal layer 423 may include the same material.

The dielectric layer 422 may include silica, for example, but is not limited thereto. In an exemplary embodiment, the dielectric layer 422 includes a material which has a high permittivity such that each of the capacitors C₁ and C₂ are formed having a high capacitance with a relatively thin thickness. Therefore, the dielectric layer 422 includes materials such as tantalum dioxide (“Ta₂O₅”), lead zirconate titanate (“Pb[ZrTi]O₃”) or (“PZT”), barium strontium titanate (“[BaSr]TiO₃”) or (“BST”), strontium titanate oxide (“SrTiO₃”) or (“STO”) and polarized lead zirconium titanate (“[PbLa][ZrTi]O₃”) or (“PLZT”), for example, but is not limited thereto.

The dielectric layer 422 may be formed by a wet-type deposition method or a dry-type deposition method. The wet-type deposition method includes a sol-gel method, for example, but is not limited thereto, while the dry-type deposition method includes sputtering, vaporization, CVD and a thermal oxidation method or other appropriate method.

A thickness of the dielectric layer 422, e.g., a thickness of the capacitors C₁ and C₂ may be about several tens of micrometers thick. However, the thickness of the capacitors C₁ and C₂ may vary in alternative exemplary embodiments of the present invention, depending on a material and a thickness of the dielectric layer 422.

The protection layer 430 may include yttrium oxide (“Y₂O₃”) or other suitable material. The fluorescent layer 440 may include phosphorus (P), for example, but is not limited thereto.

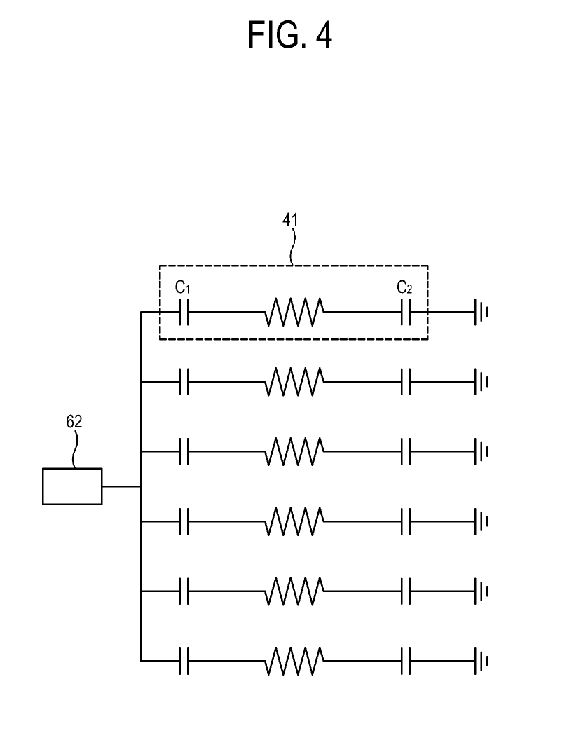

As illustrated in FIG. 4, the first electrode 420a is electrically connected to the transformer 62 and the second electrode 420b is electrically connected to an electrical ground. The capacitors C₁ and C₂ formed by the electrode main body 421 and the dielectric layer 422, as described above, are provided on the opposite ends of the lamps 41.

If a power is supplied from the transformer 62 without the capacitors C₁ and C₂, a current imbalance may result, causing a power to be over-supplied to a certain lamp 41 of the plurality of lamps due to property differences between each of the respective lamps 41.

However, in an exemplary embodiment, when a power is supplied from the transformer 62 to a plurality of lamps (only one lamp 41 of the plurality of lamps is labeled in FIG. 4), the capacitors C₁ and C₂ prevent a current to an individual lamp 41 of the plurality of lamps from converging, e.g. becoming unbalanced. As a result, the lamps 41 provide uniform brightness form the LCD device 1 according to an exemplary embodiment of the present invention. Furthermore, problems due to an over current are effectively reduced or prevented.

Therefore, a need to include a balance board or individual transformers for each respective lamp 41 in the LCD device 1 is eliminated in an exemplary embodiment of the present invention.

The dielectric layer 422 and the surface metal layer 423 may be thin and formed within the light emitting space. Therefore, the external appearance of the lamps 41 according to an exemplary embodiment of the present invention is not much different than a conventional lamp. If the lamps 41 according to the present invention replace the conventional lamp, other existing elements, e.g., a cable, a lamp supporter and a socket may be used without changing the conventional design thereof.

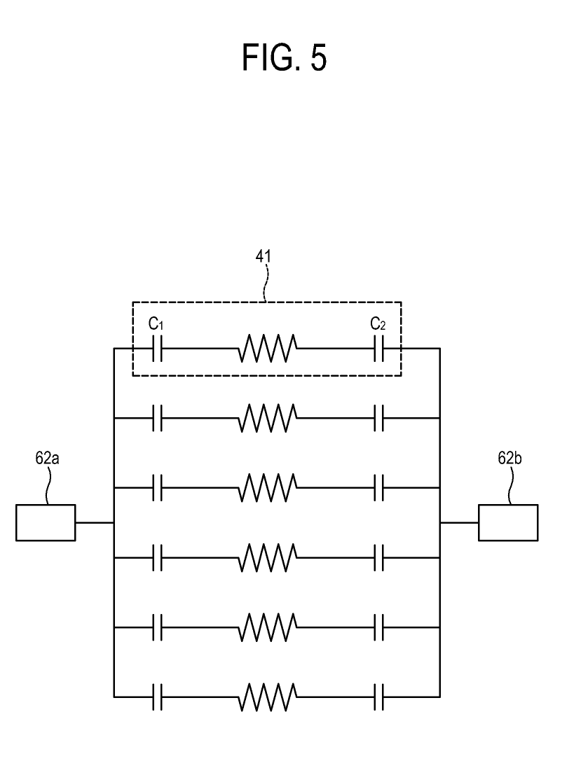

A lamp 41 according to another exemplary embodiment of the present invention will be described in further detail hereinafter with reference to FIG. 5. Common elements previously described above will not be described again.

As illustrated in FIG. 5, a first transformer 62a and a second transformer 62b are connected at a first end part of the lamp 41 nearer a capacitor C₁ and a second end part of the lamp 41 nearer a capacitor C₂, respectively.

In this arrangement, as described above, a current imbalance is effectively prevented or substantially reduced due to capacitors C₁ and C₂ of the lamp 41.

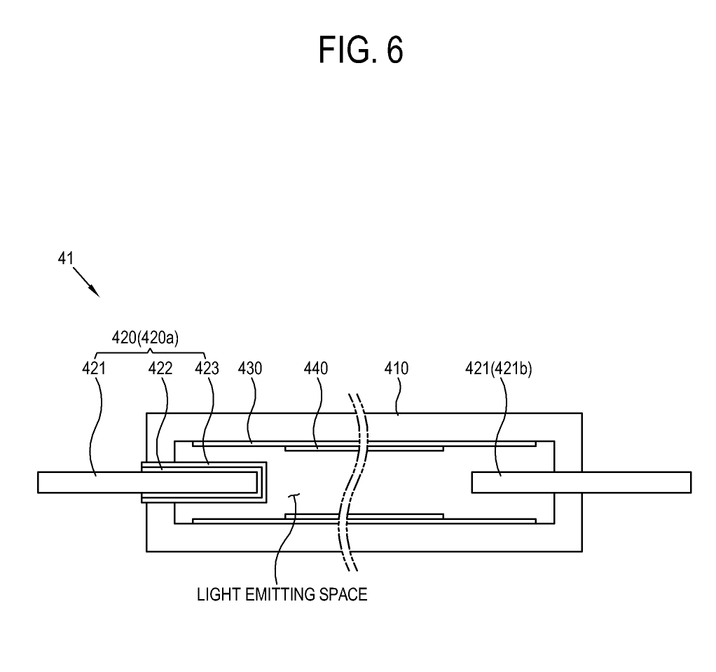

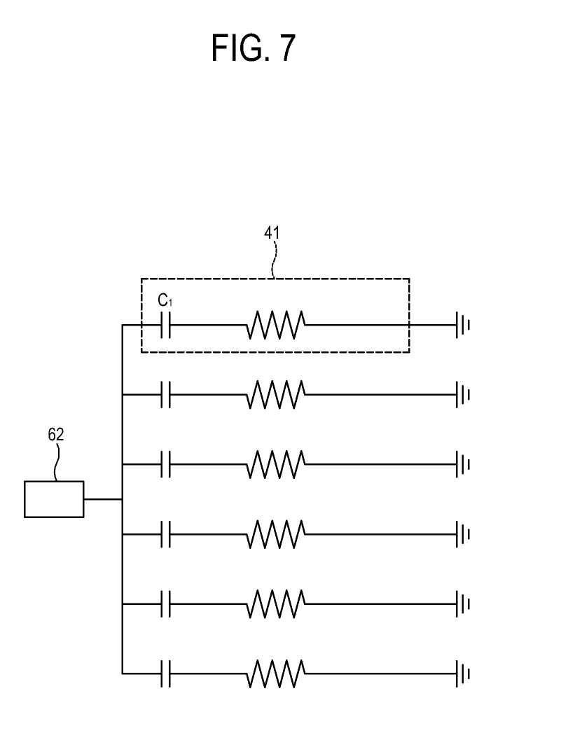

A lamp 41 according to yet another exemplary embodiment of the present invention will be described in further detail hereinafter with reference to FIGS. 6 and 7. Common elements previously described above will not be described again.

A dielectric layer 422 and a surface metal layer 423 are formed in a first electrode 420a to form a capacitor as described above. However, a second electrode 420b and a capacitor C₂ are not included in the present exemplary embodiment. Rather, an electrode main body 421 serves as a second electrode 421b.

The first electrode 420a is electrically connected to a transformer 62 while the second electrode 421b is electrically connected to an electrical ground.

As described in greater detail above, a current imbalance to a single lamp 41 of a plurality of lamps connected in electrical parallel with each other is effectively prevented or substantially reduced due to a capacitor C₁ of the lamps 41.

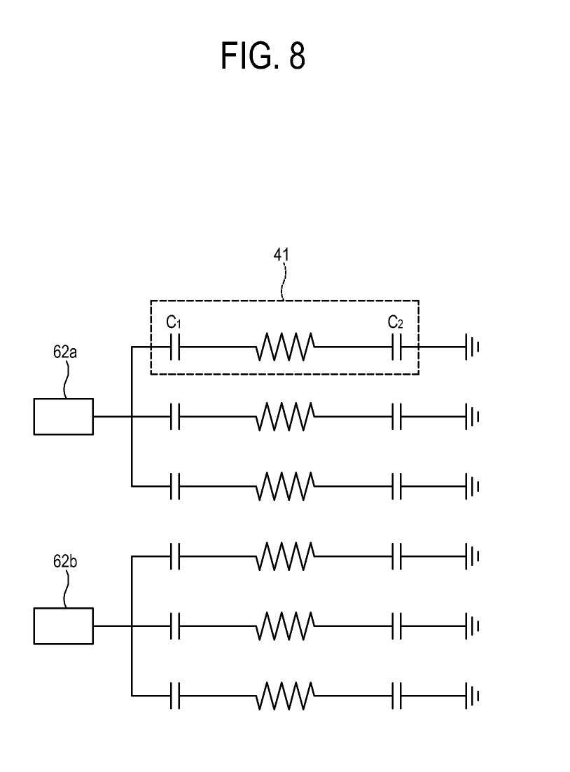

A lamp 41 according to another exemplary embodiment of the present invention will be described in further detail hereinafter with reference to FIG. 8.

As illustrated in FIG. 8, three lamps 41 of a plurality of lamps are connected with a first transformer 62a while another other three lamps 41 of the plurality of lamps are connected with a second transformer 62b. As described in greater detail above, a current imbalance to a single lamp 41 of the plurality of lamps connected in electrical parallel with each other is effectively prevented or reduced due to capacitors C₁ and C₂ of the lamps 41.

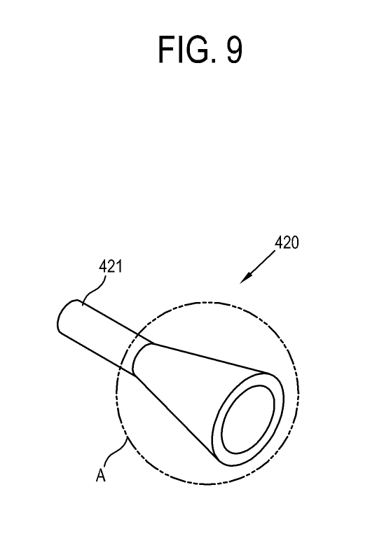

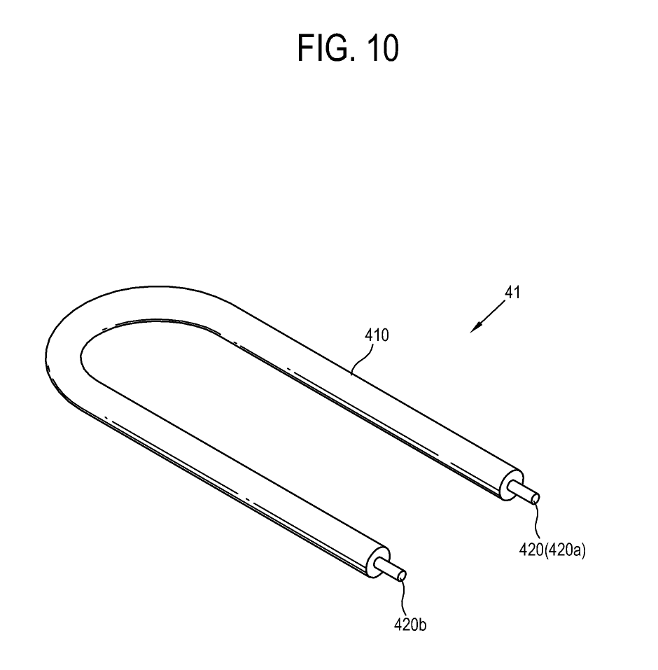

A shape of the electrodes 420 and the lamps 41 according to alternative exemplary embodiments of the present invention will now be described in further detail with reference to FIGS. 9 and 10. The shape of the electrodes 420 and the lamps 41 may vary in other alternative exemplary embodiments of the present invention, as well.

As illustrated in FIG. 9, a portion A of an electrode 420 disposed in a light emitting space (not shown) has a tapered cylindrical shape in which an end of the tapered cylindrical shape is wider near the end of the electrode 420 and tapers to another end of the tapered cylindrical shape which is narrower near an electrode main body 421. Thus, a surface area of the electrode 420 contacting the light emitting space increases due to the tapered cylindrical shape of the electrode 420, facilitating emission of electrons and thereby raising an efficiency of the lamps 41. Furthermore, the increased surface area of the electrode 420 allows a capacitor to be formed easily, thereby decreasing a required thickness of a dielectric layer 422.

In alternative exemplary embodiments of the present invention, the portion ‘A’ disposed in the light emitting space may have an uneven surface (not shown) to further increase the surface area of the electrode 420 contacting the light emitting space.

As shown in FIG. 10, a lamp 41 according to an exemplary embodiment of the present invention has a “U” shape such that electrodes 420a and 420b are adjacent to each other on respective legs of the “U” shape. As described in further detail above, exemplary embodiments of the present invention provide a lamp and a liquid crystal display device having the same which does not cause a current imbalance when a plurality of lamps connected in electrical parallel with each other are driven by a transformer.

Although the present invention has been described herein in connection with exemplary embodiments thereof, it will be apparent to those skilled in the art that various modifications and changes may be made to the exemplary embodiments of the present inventions described herein without departing from the spirit and scope of the present invention. Therefore, it should be understood that the above exemplary embodiments are not limitative, but are illustrative in all aspects, and are intended to cover various modifications and equivalent arrangements of the present invention as described in the following claims.

What is claimed is:

1. A lamp, comprising:
a tube which forms a light emitting space therein;
an electrode main body disposed in a first end part of the tube;
a dielectric layer formed on the electrode main body disposed in the first end part of the tube; and
a surface metal layer formed on the dielectric layer.

2. The lamp according to claim 1, wherein a work function of the electrode main body is greater than a work function of the surface metal layer.

3. The lamp according to claim 1, wherein the electrode main body comprises at least one of copper, aluminum and stainless steel.

4. The lamp according to claim 1, wherein the surface metal layer comprises at least one of nickel (Ni), niobium (Nb), molybdenum (Mo) and cesium (Cs).

5. The lamp according to claim 1, wherein the dielectric layer comprises at least one of silica (SiO₂), tantalum dioxide (Ta₂O₅), lead zirconate titanate [Pb(Zr,Ti)O₃] or (PZT), barium strontium titanate [(BaSr)TiO₃] or (BST), strontium titanate oxide (SrTiO₃) or (STO) and polarized lead zirconium titanate (PbLa)ZrTi)O₃) or (PLZT).

6. The lamp according to claim 1, wherein the tube comprises glass, and a permittivity of the dielectric layer is larger than a permittivity of the tube.

7. The lamp according to claim 1, further comprising a protection layer which is formed on a first inner surface of the tube, and a fluorescent layer which is formed on the protection layer.

8. The lamp according to claim 1, wherein the electric main body has a tapered cylindrical shape, in which a first end of the tapered cylindrical shape is wider near the light emitting space and which tapers to a narrower second end of the tapered cylindrical shape which is near a first end of the electrode main body.

9. A liquid crystal device comprising:
a liquid crystal display panel;
a plurality of lamps disposed behind the liquid crystal display panel; and
an inverter which supplies power to the plurality of lamps,
the respective lamps comprising a tube which forms a light emitting space therein and an electrode disposed in a first end part of the tube, the electrode comprising:
an electrode main body;
a dielectric layer formed on the electrode main body; and
a surface metal layer formed on the dielectric layer.

10. The liquid crystal display device according to claim 9, wherein the inverter comprises a transformer electrically connected to the plurality of lamps, the plurality of lamps being connected in electrical parallel to each other.

11. The liquid crystal display device according to claim 9, wherein a work function of the electrode main body is greater than a work function of the surface metal layer.

12. The liquid crystal display device according to claim 9, wherein the electrode main body comprises at least one of copper, aluminum and stainless steel.

13. The liquid crystal display device according to claim 9, wherein the surface metal layer comprises at least one of nickel (Ni), niobium (Nb), molybdenum (Mo) and cesium (Cs).

14. The liquid crystal display device according to claim 9, wherein the dielectric layer comprises at least one of silica (SiO₂), tantalum dioxide (Ta₂O₅), lead zirconate titanate [(Pb(ZrTi)O₃] or (PZT), barium strontium titanate [(BaSr)TiO₃] or (BST), strontium titanate oxide (SrTiO₃) or (STO) and polarized lead zirconium titanate [(PbLa)(ZrTi)O₃] or (PLZT).

15. The liquid crystal display device according to claim 9, wherein the tube comprises glass, and a permittivity of the dielectric layer is larger than a permittivity of the tube.
